(19) United States
(12) Patent Application Publication
(10) Pub. No.: US 2025/0144818 A1
(43) Pub. Date: May 8, 2025

(54) SYSTEMS AND METHODS FOR DISRUPTING RESONANCE IN VACUUM CUP ASSEMBLIES USED WITH PROGRAMMABLE MOTION DEVICES

(71) Applicant: Berkshire Grey Operating Company, Inc., Bedford, MA (US)

(72) Inventors: Bretton ANDERSON, Westford, MA (US); Calvin TOOTHAKER, Medford, MA (US)

(21) Appl. No.: 18/919,816

(22) Filed: Oct. 18, 2024

Related U.S. Application Data
(63) Continuation of application No. 17/167,536, filed on Feb. 4, 2021, now Pat. No. 12,157,223.
(60) Provisional application No. 62/970,208, filed on Feb. 5, 2020.

(51) Int. Cl. B25J 15/06

(52) U.S. Cl. CPC B25J 15/0683

(57) ABSTRACT

An end-effector for a programmable motion device is disclosed for use with a vacuum source. The end-effector includes an end-effector attachment portion for attaching the end-effector to the programmable motion device, the end-effector attachment portion including a vacuum channel coupled to the vacuum source, a contact portion of the end-effector for contacting an object to be acquired by the contact portion of the end-effector, a flexible intermediate section including a contact end of the flexible intermediate portion proximate the contact portion of the end-effector, the flexible intermediate section of the end-effector being intermediate the end-effector attachment portion and the contact portion of the end-effector, the flexible intermediate section including a bellows portion that extends radially outwardly of the vacuum channel, and a bellows insert that extends into the flexible intermediate section.

### PRIORITY

The present application is a continuation of U.S. patent application Ser. No. 17/167,436, filed Feb. 4, 2021, now U.S. Patent No. 12, 157,223, issued Dec. 3, 2024, which claims priority to U.S. Patent Application Ser. No. 62/970,208 filed Feb. 5, 2020, the disclosures of which are hereby incorporated by reference in their entireties.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear).

Many end-effectors employ vacuum pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion, that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object.

When a good seal is not created between a flexible vacuum cup and an object however, or when the air-flow within the end-effector causes very noisy air-flow, sometimes a substantial amount of noise may result, and the noise level may be above safe limits if human personnel are close to the programmable motion device. Other types of end-effectors, however, including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects.

There remains a need therefore, for an end-effector system in a programmable motion system that may select and grasp any of a wide variety of objects, and then move the acquired objects very quickly to a new location while not producing an unacceptable level of noise.

### SUMMARY

In accordance with an aspect, the invention provides an end-effector for a programmable motion device for use with a vacuum source. The end-effector includes: an end-effector attachment portion for attaching the end-effector to the programmable motion device, the end-effector attachment portion including a vacuum channel coupled to the vacuum source, a contact portion of the end-effector for contacting an object to be acquired by the contact portion of the end-effector, a flexible intermediate section including a contact end of the flexible intermediate portion proximate the contact portion of the end-effector, the flexible intermediate section of the end-effector being intermediate the end-effector attachment portion and the contact portion of the end-effector, the flexible intermediate section including a bellows portion that extends radially outwardly of the vacuum channel, and a bellows insert that extends into the flexible intermediate section a sufficient distance to inhibit a substantial amount of air-flow from entering the bellows portion yet does not significantly inhibit freedom of movement of the flexible intermediate section.

In accordance with a further aspect, the invention provides a programmable motion device for use with a vacuum source. The programmable motion device includes an end-effector including: an end-effector attachment portion for attaching the end-effector to the programmable motion device, said end-effector attachment portion including a vacuum channel coupled to the vacuum source, a contact portion of the end-effector for contacting an object to be acquired by the contact portion of the end-effector, a flexible intermediate section including a contact end of the flexible intermediate portion proximate the contact portion of the end-effector, the flexible intermediate portion being intermediate the end-effector attachment portion and the contact portion of the end-effector, the flexible intermediate section including a bellows portion that extends radially outwardly of the vacuum channel, and a bellows insert that extends into the flexible intermediate section, disturbing any resonance of moving air within the bellows portion.

In accordance with a further aspect, the invention provides a method of operating a programmable motion device with a vacuum source. The method includes: providing an end-effector attachment portion for attaching an end-effector to the programmable motion device, said end-effector attachment portion including a vacuum channel coupled to the vacuum source, providing a contact portion of the end-effector for contacting an object to be acquired by the contact portion of the end-effector, providing a flexible intermediate section of the end-effector that is intermediate the end-effector attachment portion and the contact portion of the end-effector, the flexible intermediate section including a bellows portion that extends radially outwardly of the vacuum channel, providing a bellows insert that extends into the flexible intermediate section, and disturbing any resonance of moving air within the bellows portion.

### BRIEF DESCRIPTION OF THE DRAWINGS

The following description may be further understood with reference to the accompanying drawings in which:

FIG. 1 shows an illustrative diagrammatic view of a programmable motion system with an end-effector in accordance with an aspect of the present invention;

FIG. 2 shows an illustrative diagrammatic partial sectional view of an end-effector that may be used in the system of FIG. 1;

FIG. 3 shows an illustrative diagrammatic sectional view of a portion of the end-effector of FIG. 2;

FIG. 4 shows an illustrative diagrammatic side view of relative component parts of the end-effector of FIG. 2;

FIG. 5 shows an illustrative diagrammatic partial sectional view of the end-effector used in the system of FIG. 1;

FIG. 6 shows an illustrative diagrammatic partial side view of relative component parts of the end-effector of FIG. 5;

FIG. 7 shows an illustrative diagrammatic partial sectional exploded view of the end-effector of FIG. 5;

FIG. 8 shows an illustrative diagrammatic partial side view of relative component parts of the end-effector of FIG. 5 showing the attachment unit;

FIG. 9 shows an illustrative diagrammatic center-sectional view of the end-effector of FIG. 5;

FIG. 10 shows an illustrative diagrammatic center-sectional view similar to that in FIG. 9 of an end-effector in accordance with another aspect of the present invention;

FIG. 11 shows an illustrative diagrammatic exploded view of an end-effector in accordance with a further aspect of the invention that includes a bellows insert that includes a plurality of position securement features;

FIG. 12 shows an illustrative diagrammatic exploded partial section view of the end-effector of FIG. 11; and

FIG. 13 shows an illustrative diagrammatic partial side sectional view of the end-effector of FIG. 11.

The drawings are shown for illustrative purposes only.

### DETAILED DESCRIPTION

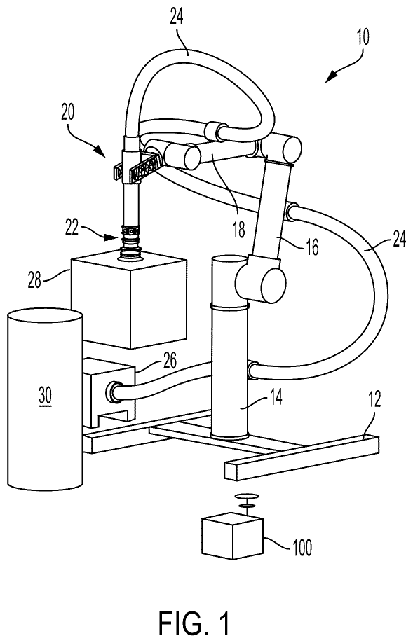

The invention generally relates to vacuum end-effectors on programmable motion devices. FIG. 1 shows a programmable motion device 10 that includes a base 12, a base section 14, and articulated arm sections 16 and 18, as well as a vacuum attachment section 20, and end-effector 22. A high flow vacuum is provided via vacuum hose 24 from a high vacuum source 26. The programmable motion device 10 may be used, under the control of one or more computer processing systems 100, to grasp and move various objects 28, 30 using the high flow vacuum provided at the end-effector 22.

In high air-flow vacuum applications, a vacuum is provided that has a high air-flow, for example, an air-flow of at least about 100 cubic feet per minute, and a vacuum pressure at the end-effector of no more than about 100,000 Pascals below atmospheric, or 85,000 Pascals below atmospheric or 65,000 Pascals below atmospheric. Applicants have discovered that when such a high air-flow vacuum is provided it may cause particularly resonant high air-flow within the end-effector creating a loud (sometimes whistling) noise.

Applicants have further discovered that air moving through a suction cup and in particular, past the bellows cavity produces resonances for certain combinations of air speeds and cavity geometries. It is undesirable to change the vacuum cup assembly when the bellows, cup shape, and collar specifications are selected to work for a desired application. There is a need therefore, to address bellows resonances for certain vacuum cup assemblies and air speeds.

The high flow vacuum may be provided, for example, by a blower, having a vacuum pressure at the end-effector of no more than about 100,000 Pascals below atmospheric, or 85,000 Pascals below atmospheric or 65,000 Pascals below atmospheric (e.g., about 50,000 Pascals below atmospheric or 7.25 psi). A vacuum cup of an end-effector for example, may have an internal vacuum passage dimension (e.g., diameter if round) of about 0.5 inches to about 1.5 inches at a most narrow portion of the vacuum passage at the end-effector. In accordance with various aspects, the components of the end-effector need not be circular in cross-sectional shape, and may be polygonal, including square or triangular.

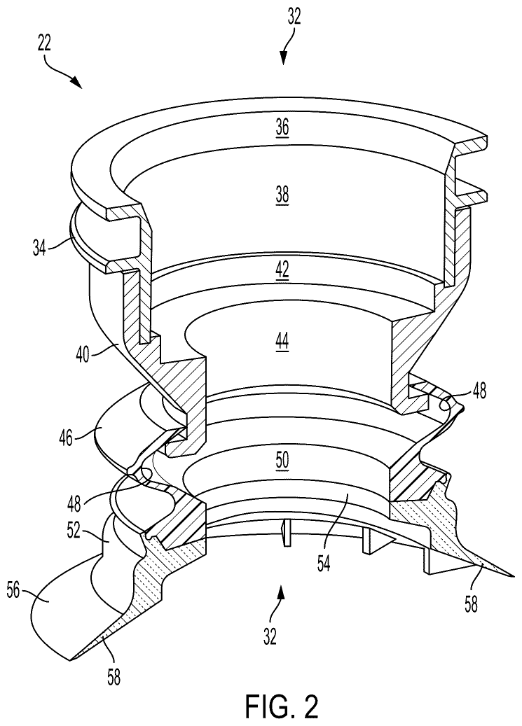

With reference to FIG. 2, it may be seen that the internal vacuum passage 32 includes several components, each with potentially different inner dimensions. In particular, the end-effector 22 includes an attachment portion 34 for attaching to a programmable motion device 10 that includes an angled large inner dimension portion 36 as well as a vertical large inner dimension section 38. A collar 40 is attached to the attachment portion 34, and includes inner dimension sections 42, 44. A flexible bellows 46 that is formed, for example, of compliant elastomeric material has a varying inner dimension portion 48 forming the bellows, and a vertical inner dimension portion 50. A vacuum cup 52 is attached to the bellows, and has a vertical inner dimension portion 54 and an expanding inner dimension that leads to the cup lip 56 which provides the opening at the underside 58 thereof for the end-effector 22.

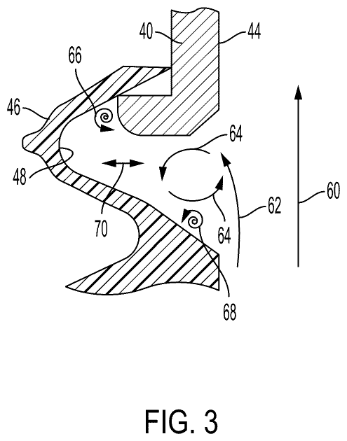

Applicants have discovered that when the smallest inner dimension portions on either side of the flexible bellows portion (e.g., 44, 50, 54 in the end-effector of FIG. 2) either align or are within plus or minus 10 percent of the size of each other, substantial noise may result when using a high flow vacuum source. FIG. 3 shows a cut-away portion of one side of the internal vacuum passage 32 (shown in FIG. 2), showing portions of the bellows 46 and the collar 40. As the high flow vacuum is drawn (shown diagrammatically at 60), some air travels will split on the trailing edge of the surface 50 and be directed toward the underside of the collar (shown diagrammatically at 62), which air may become entrained in a circular pattern (shown diagrammatically at 64) crossing the fast moving air shown at 62. This may cause additional vortexes (shown diagrammatically at 66 and 68) and may cause an oscillation to occur (shown diagrammatically at 70) within the bellows 46, any or all of which may result in substantial unwanted noise during high flow vacuum use.

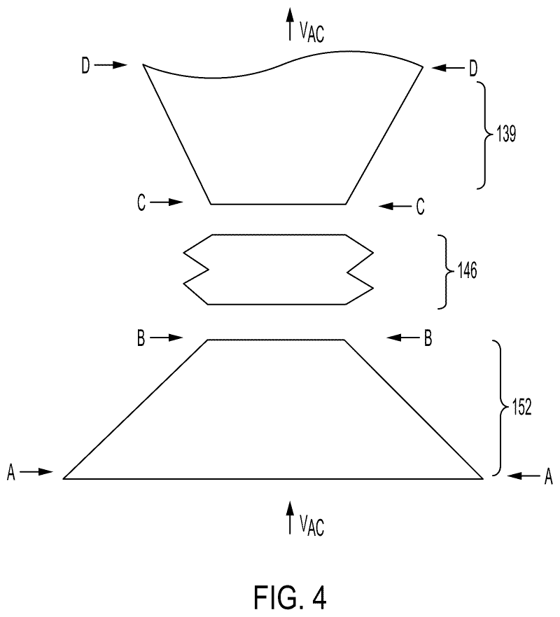

A fundamental challenge of systems of high flow vacuum systems is that it is desirable to obtain both high volume air-flow at the contact portion of the end-effector, yet permit flexibility of the end-effector as it contacts and grasps objects without significant attendant noise. With reference to FIG. 4, for example, a dimension of the vacuum channel may decrease from the contact portion 152 to a flexible intermediate portion 146 as shown at dimension A decreasing to dimension B in FIG. 4. The smaller dimension B (relative dimension A) facilitates creating the high air-flow vacuum at the contact portion 152. The flexible intermediate portion 146 (e.g., a bellows) provides flexibility in accommodating variations in object contact surfaces and contact experiences that the end-effector may undergo. An attachment portion 139 (e.g., an attachment collar and/or attachment unit) with a smallest internal dimension C increases in inner dimension to D as also shown in FIG. 4. The flexible intermediate portion 146 is positioned between the smaller dimension B of the contact portion 152, and the smaller dimension C of the attachment portion 139.

A narrow inner dimension vacuum channel is maintained at the contact end of the flexible intermediate portion as shown at B in FIG. 4 to provide the high flow vacuum, which widens from dimension A at the contact surface 158 of the contact portion 152 (e.g., vacuum cup). The contact portion may additionally provide some flexibility, but the challenge exists in maintaining the high air-flow vacuum through the flexible intermediate portion without attendant high levels of noise.

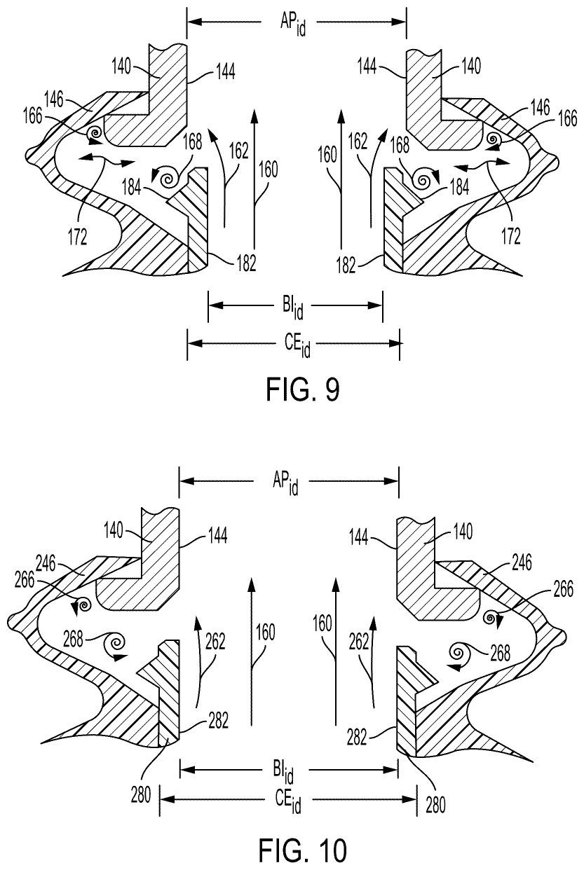

In accordance with various aspects, the invention provides a bellows insert that extends into the flexible intermediate section a sufficient distance to inhibit a substantial amount of air-flow from entering the bellows portion yet does not significantly inhibit freedom of movement of the flexible intermediate section. In accordance with further specific aspects, the bellows insert extends into the flexible intermediate section, disturbing any resonance of moving air within the bellows portion. In accordance with further aspects and with reference to FIGS. 9 and 10, the end-effector attachment portion has a smallest internal dimension of AP_{id}, the contact end of the flexible intermediate portion has a smallest internal dimension of CE_{id}; and the values AP_{id} and CE_{id} are within 15% or 10% of each other. In accordance with further aspects, the end-effector system may produce audible noise when the end-effector attachment portion has a smallest internal dimension of AP_{id}, the bellows insert has a smallest internal dimension of BI_{id}; and the values AP_{id} and BI_{id} are within 15% or 10% of each other. For example, if BI_{id} is within 15% of AP_{id}, then bellows inserts in accordance with an aspect of the invention may be used. Surprisingly, the use of designs in accordance with various aspects of the invention reduces the noise generated by a compliant vacuum cup when used in such high air-flow application.

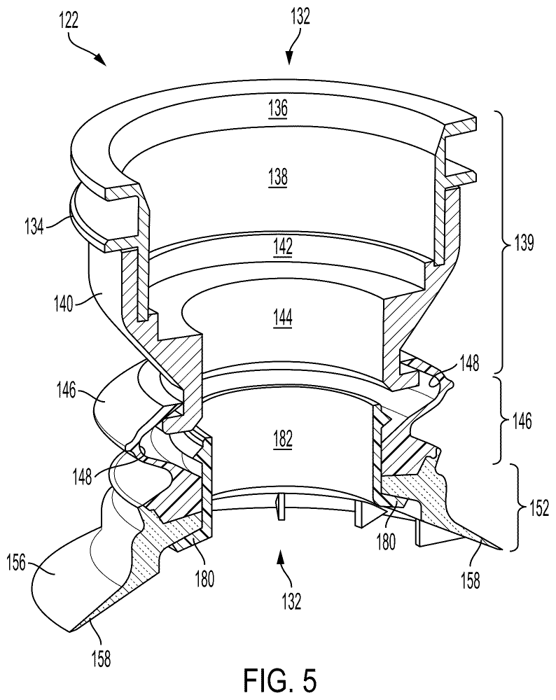

With reference to FIG. 5, the invention provides in accordance with certain aspects, an end-effector 122 as well as the use of the end-effector 122 in the system including the programmable motion device 10 of FIG. 1 in place of the end-effector 22. The end-effector 122 provides a vacuum channel 132 that is provided, in part, by attachment unit 134 having inner dimension portions 136 and 138, collar 146 having inner dimension portions 142 and 144, bellows 146 having varying inner dimension portions 148, and vacuum cup 156. The end-effector 122 further includes a bellows insert 180 having an inner dimension 182. The presence of the bellows may not significantly inhibit movement (e.g., restrict a change in shape of at least 10%, 20%, 50% or 75%) of the flexible bellows in accordance with various aspects of the invention.

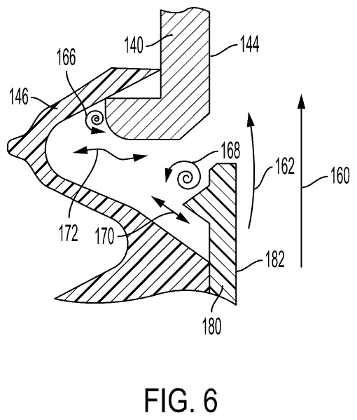

With reference to FIG. 6, as the high air-flow vacuum is drawn (shown diagrammatically at 160), very little air may be directed toward the underside of the collar 140. While some air within the bellows may develop small vortexes (shown diagrammatically at 166, 168), and some air may develop small oscillations (shown diagrammatically at 170), any movement of air may generally be non-uniform (shown diagrammatically at 172). Most significantly, the rate of movement of air within the bellows may be greatly reduced, and large oscillations of air may be reduced or eliminated, resulting in a substantial decrease in unwanted noise during high flow vacuum use with the programmable motion device 10 of FIG. 1 where the end-effector 122 is substituted for the end-effector 22.

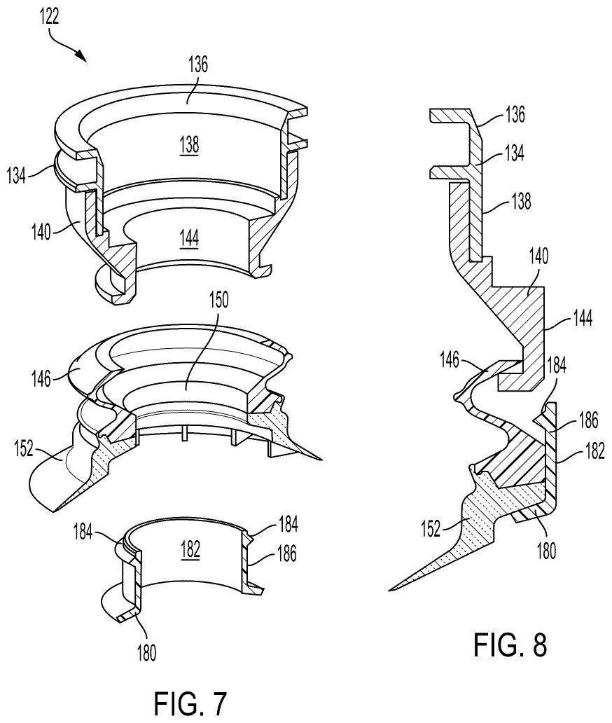

FIG. 7 shows an exploded view of the combined attachment unit 134 and collar 140, the flexible intermediate portion 146 including the vacuum cup 152, and the bellows insert 180. With further reference to FIG. 8, the inner dimension portion 144 of the collar 140, and the inner dimension portion 150 of the flexible intermediate portion 146 may be aligned or closely aligned. Applicants have discovered that in such arrangement, under certain conditions of high flow vacuum use, substantial unwanted noise may result absent a bellows insert 180. As shown in FIGS. 7 and 8, the bellows insert 180 includes a head portion on a protruding end of the bellows insert that extends into the bellows on a bellows insert extension 186, yet does not negatively affect substantial movement of the flexible intermediate portion 146.

With reference to FIG. 9, which shows both sides of the attachment collar 140 (that extends from the attachment unit 134 of FIGS. 5, 7 and 8) and the flexible intermediate portion 146, including the vacuum cup 152, and the bellows insert 180. With reference again to FIG. 8, the inner dimension portion 144 of the collar 140, and the inner dimension portion 150 of the flexible intermediate portion 146 may be aligned or closely aligned. By use of the bellows insert 180, very little air will split on the trailing edge of the inner surface 182 of the bellows insert 180 and be directed toward the underside of the attachment collar 140. While some air within the bellows may develop small vortexes (shown diagrammatically at 166, 168), any movement of air will generally be non-uniform (shown diagrammatically at 172). Most significantly, the rate of movement of air within the bellows will be greatly reduced, and large oscillations of air will be reduced or eliminated, resulting in a substantial decrease in unwanted noise during high flow vacuum use as discussed above. The protrusion 184 (or securement feature) may be provided to facilitate holding the bellow inset in place.

As further shown in FIG. 9, the attachment portion (e.g., collar 144) will have a smallest internal dimension (AP_{id}), the contact end of the flexible intermediate portion will have a smallest internal dimension (CE_{id}), and the bellows insert will have a smallest internal dimension (BI_{id}) as shown. The smallest internal dimension of the attachment portion (AP_{id}) and the smallest internal dimension (CE_{id}) of the contact end of the flexible intermediate portion may vary no more than 15% of each other in internal dimension, and preferably may vary no more than 10% of each other in internal dimension. Further, the end-effector system may produce audible noise when the smallest internal dimension of the attachment portion (AP_{id}) and the smallest internal dimension (BI_{id}) of the bellows insert may vary no more than 15% of each other in dimension, e.g., diameter, and preferably may vary no more than 10% of each other in dimension, e.g., diameter. Again, the use of designs in accordance with an aspect of the invention may reduce the noise generated in a compliant end-effector when used in such a high air-flow application.

In accordance with further aspects of the invention and with reference to FIG. 10, the contact end of the flexible intermediate portion 246 may be provided that has a smallest internal dimension (CE_{id}) that is larger than the internal dimension of the attachment portion (AP_{id}) such that the smallest internal dimension (BI_{id}) of the bellows insert is aligned or nearly aligned with the smallest internal dimension of the attachment portion (AP_{id}) (resulting in a whistle absent a bellows insert in accordance with an aspect of the invention). Again, the smallest internal dimension of the attachment portion (AP_{id}) and the smallest internal dimension (CE_{id}) of the contact end of the flexible intermediate portion may vary no more than 15% of each other in dimension (e.g., diameter), and preferably may vary no more than 10% of each other in dimension (e.g., diameter). Further, the smallest internal dimension of the attachment portion (AP_{id}) and the smallest internal dimension (BI_{id}) of the bellows insert may vary no more than 15% of each other in dimension (e.g., diameter), and preferably may vary no more than 10% of each other in dimension (e.g., diameter). While some air within the bellows may develop small vortexes (shown diagrammatically at 266, 268), any movement of air will generally be non-uniform. Most significantly, the rate of movement of air within the bellows will be greatly reduced, and large oscillations of air will be reduced or eliminated, resulting in a substantial decrease in unwanted noise during high flow vacuum use as discussed above.

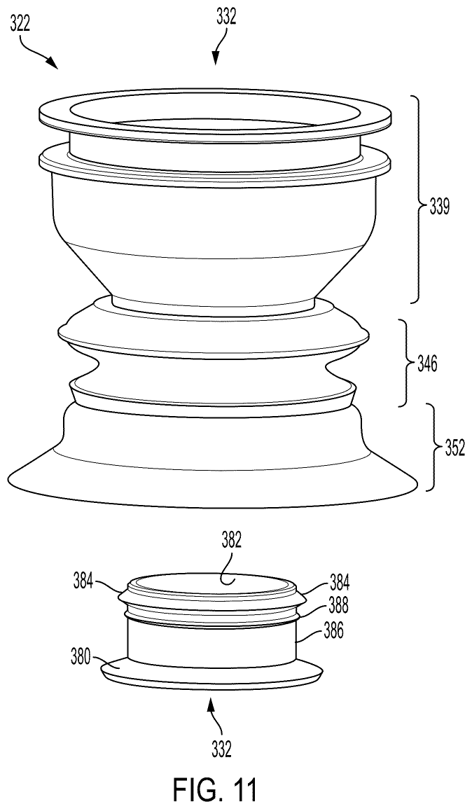

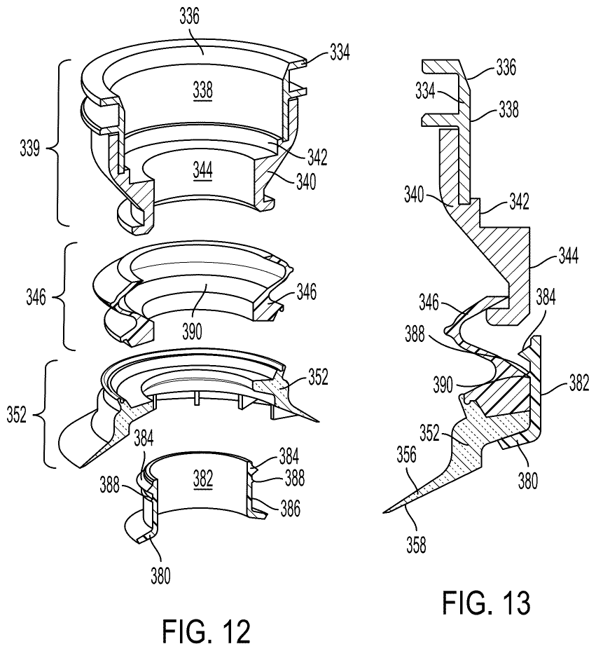

In accordance with a further embodiment, the invention provides an end-effector 322 and a programmable motion device 10 (of FIG. 1) including the end-effector 322 (of FIGS. 11-13). The end-effector 322 provides a vacuum channel 332 that is provided, in part, by an attachment section 339 that includes an attachment unit 334 having inner dimension portions 336 and 338, and a collar 340 having inner dimension portions 342 and 344. The end-effector 322 also includes a flexible intermediate portion 346 including a bellows having varying inner dimension portions 348, and a contact section 356 including a vacuum cup. The end-effector 322 further includes a bellows insert 380 having an inner dimension 382. The bellows insert 380 includes a head portion 384 (optionally to facilitate retention) on a protruding end of the bellows insert that extends into the bellows on a bellow insert extension 386, yet does not negatively affect substantial movement of the flexible intermediate portion 346. Additionally, the bellows insert includes a shoulder engagement feature 388 that is secured against a shoulder 390 of the flexible intermediate portion 346 as discussed below with reference to FIGS. 12 and 13.

FIG. 12 shows an exploded view of the combined attachment unit 334 and collar 340, the flexible intermediate portion 346 including the vacuum cup 352, and the bellows insert 380. With further reference to FIG. 13, the inner dimension portion 344 of the collar 340, and the inner dimension portion 350 of the flexible intermediate portion 346 may be aligned or closely aligned. Applicants have discovered that in such arrangement, under certain conditions of high flow vacuum use, substantial unwanted noise may result absent a bellows insert 380. The shoulder engagement feature 388 is secured against the shoulder 390 of the flexible intermediate portion 346. The shoulder 390 and an outer surface of the bellows insert 380 may additionally serve to secure the vacuum cup 352 to the flexible intermediate portion 346.

Those skilled in the art will appreciate that numerous modifications and variations may be made to the above disclosed embodiments without departing from the spirit and scope of the present invention.

What is claimed is:

1.-33. (canceled)

34. An end-effector for a programmable motion device for use with a vacuum source, said end-effector comprising:
an end-effector attachment portion for attaching the end-effector to the programmable motion device, said end-effector attachment portion including a collar forming a vacuum channel of a first dimension, the collar coupled to the vacuum source;
a contact portion of the end-effector for contacting an object to be acquired by the contact portion of the end-effector, the contact portion having an opening size closely aligned to the first dimension;
a flexible intermediate section including a contact end-proximate the contact portion of the end-effector, said flexible intermediate section of the end-effector being intermediate the end-effector attachment portion and the contact portion of the end-effector, said flexible intermediate section including a bellows portion that extends radially outwardly of the vacuum channel and including an inner channel opening size closely aligned to the first dimension; and
a bellows insert extension that extends into the flexible intermediate section to inhibit air flow from entering the bellows portion, wherein the bellows insert does not significantly inhibit freedom of movement of the flexible intermediate section, and wherein the bellows insert includes a shoulder engagement feature that is secured against a shoulder of the flexible intermediate section.

35. The end-effector as claimed in claim 34, wherein the flexible intermediate section is formed of a polymeric material.

36. The end-effector as claimed in claim 34, wherein the vacuum source provides high flow vacuum of at least 100 cubic feet per minute.

37. The end-effector as claimed in claim 36, wherein the vacuum source provides high flow vacuum at a vacuum pressure of no more than 100,000 Pascals below atmospheric pressure.

38. The end-effector as claimed in claim 36, wherein the vacuum source provides high flow vacuum at a vacuum pressure of no more than 85,000 Pascals below atmospheric pressure.

39. The end-effector as claimed in claim 36, wherein the vacuum source provides high flow vacuum at a vacuum pressure of no more than 65,000 Pascals below atmospheric pressure.

40. The end-effector as claimed in claim 34, wherein the first dimension is between 0.5 inches and 1.5 inches.

41. An end-effector for a programmable motion device for use with a vacuum source, said end-effector comprising:
an end-effector attachment portion for attaching the end-effector to the programmable motion device, said end-effector attachment portion including a collar forming a vacuum channel of a first dimension, the collar coupled to the vacuum source;
a contact portion of the end-effector for contacting an object to be acquired by the contact portion of the end-effector;
a flexible intermediate section including a contact end proximate the contact portion of the end-effector, said flexible intermediate section of the end-effector being intermediate the end-effector attachment portion and the contact portion of the end-effector, said flexible intermediate section including a bellows portion that extends radially outwardly of the vacuum channel and including an inner channel opening size closely aligned to the first dimension at the end-effector attachment portion; and
a bellows insert extension that fits within the contact portion of the end-effector and extends into the flexible intermediate section to inhibit air flow from entering the bellows portion, wherein the bellows insert does not significantly inhibit freedom of movement of the flexible intermediate section, and wherein the bellows insert includes a shoulder engagement feature that is secured against a shoulder of the flexible intermediate section, the bellows insert extension including a vacuum channel having an inner channel opening size closely aligned to the first dimension.

42. The end-effector as claimed in claim 41, wherein the flexible intermediate section is formed of a polymeric material.

43. The end-effector as claimed in claim 41, wherein the vacuum source provides high flow vacuum of at least 100 cubic feet per minute.

44. The end-effector as claimed in claim 43, wherein the vacuum source provides high flow vacuum at a vacuum pressure of no more than 100,000 Pascals below atmospheric pressure.

45. The end-effector as claimed in claim 43, wherein the vacuum source provides high flow vacuum at a vacuum pressure of no more than 85,000 Pascals below atmospheric pressure.

46. The end-effector as claimed in claim 43, wherein the vacuum source provides high flow vacuum at a vacuum pressure of no more than 65,000 Pascals below atmospheric pressure.

47. The end-effector as claimed in claim 41, wherein the first dimension is between 0.5 inches and 1.5 inches.

48. A method of operating a programmable motion device with a high flow vacuum source, the method comprising:
providing an end-effector to the programmable motion device, said end-effector attachment portion including a vacuum channel with a first dimension coupled to the high flow vacuum source;
providing a contact portion of the end-effector for contacting an object to be acquired by the contact portion of the end-effector, the contact portion including a vacuum channel with a second dimension;
providing a flexible intermediate section of the end-effector that is intermediate the end-effector attachment portion and the contact portion of the end-effector, said flexible intermediate section including a bellows portion that extends radially outwardly of the vacuum channel to provide a bellows cavity, the flexible intermediate section having a vacuum channel with a third dimension; and
shielding the flow of vacuum into the bellows cavity with an insert that extends into the flexible intermediate section to inhibit air flow from entering the bellows portion such that any resonance of moving air within the bellows portion is disturbed, wherein the insert does not close off the bellows cavity when the bellows is not contracted.

49. The method according to claim 48, wherein the first dimension, the second dimension, and the third dimension are closely aligned.

50. The method according to claim 48, wherein the insert includes a vacuum channel with a fourth dimension, and the first dimension, the third dimension, and the fourth dimension are closely aligned.

51. The method according to claim 48, wherein the high flow vacuum source provides a flow of vacuum of at least 100 cubic feet per minute.

52. The method according to claim 51, wherein the high flow vacuum source provides a vacuum pressure of no more than 100,000 Pascals below atmospheric pressure.

53. The method according to claim 51, wherein the high flow vacuum source provides a vacuum pressure of no more than 85,000 Pascals below atmospheric pressure.

54. The method according to claim 51, wherein the high flow vacuum source provides a vacuum pressure of no more than 65,000 Pascals below atmospheric pressure.
